(19) United States
(12) Patent Application Publication
(10) Pub. No.: US 2006/0282430 A1
(43) Pub. Date: Dec. 14, 2006

(54) Fuzzy matching of text at an expected location

(76) Inventors: David Lane Diamond, Mont Vernon, NH (US); Michael S. Rubino, Nashua, NH (US); Jeremy Lizt, San Francisco, CA (US)

Correspondence Address: PERMAN & GREEN, LLP, 425 POST ROAD, FAIRFIELD, CT, 06824, US

(21) Appl. No.: 11/150,070

(22) Filed: Jun. 10, 2005

(51) Int. Cl. G06F 17/30

(52) U.S. Cl. 707/6

(57) ABSTRACT

A method and system for searching for text in a document. In one embodiment, the method includes comparing a signature of text to be located with a signature of each section of text in the document. A distance from an expected location of the text to be matched is computed and compared to a location of each section of text in the document. An exact match of the signature of text to be located that is nearest to the expected location of the text to be located is sought. If an exact match of the signature is not found at the expected location, a close match to the signature, that is nearest to the expected location, is sought. If the exact match is found, the location of the exact match is identified as the location of the text being searched for. If the exact match is not found, and a close match is identified, the close match is identified as the location of the text being searched for. If a close match is not identified, the search is unsuccessful and the text can be considers as an orphan by the application using the invention.

### CROSS-REFERENCE TO RELATED APPLICATIONS

The present invention is related to U.S. patent application Ser. No. ______, filed on ______, 2005 as Express Mail No. EV 327711492 US, entitled COLLABORATIVE DOCUMENT REVIEW, by David Lane Diamond, Michael S. Rubino, and Jeremy Lizt, (Attorney Docket Number 835-010955-US(PAR); OID-2004-080-01) and assigned to the assignee of the instant application, the disclosure of which is incorporated herein by reference in its entirety.

### BACKGROUND OF THE INVENTION

1. Field of the Invention

The present invention relates to document management and, more particularly, to locating text or information in a document.

2. Brief Description of Related Developments

The problem is matching of text expected to be found at a certain location within a document. It is necessary to allow the movement of the text and the alteration of the text and still be able to match the text. Prior to the invention, text could be matched character-by-character with each section of text in the document. Character-by-character matching of text does not allow for the text to be altered.

### SUMMARY OF THE INVENTION

The present invention is directed to searching for text in a document. In one embodiment, the method includes comparing a signature of text to be located with a signature of each section of text in the document. A distance from an expected location of the text to be matched is computed and compared to a location of each section of text in the document. An exact match of the signature of text to be located that is nearest to the expected location of the text to be located is sought. If an exact match of the signature is not found at the expected location, a close match to the signature, that is nearest to the expected location, is sought. If the exact match is found, the location of the exact match is identified as the location of the text being searched for. If the exact match is not found, and a close match is identified, the close match is identified as the location of the text being searched for. If a close match is not identified, the search is unsuccessful and the text can be considered as an orphan by the application using the invention.

In another aspect, the present invention is directed to a method of matching a section of text to be located to the existing text in a document. In one embodiment, a signature is created for the section of text to be located. A signature is then created for each section of existing text in the document. The signature can include a number of elements in a pre-determined order. A first element position or set of positions can be assigned for each letter of an alphabet of a language of the text and the numeric value of the element can identify a number of occurrences of the letter in the section for which the signature is being created. Another element position or set of positions can be used to identify a number of occurrences of any numeric in the section for which the signature is being created. A further element position or set of positions can be used to identify a number of occurrences of any separator in the section for which the signature is being created. A part score is calculated for each signature by summing the value of the element positions. A part score for the text to be matched is compared, in turn, with the part score for each section of text in the document. It is determined whether or not there is an exact match of part scores. A distance from an expected location of the text to be matched in the document is compared with the location of each section of text in the document. This can include providing each segment of the document with a sequence number, with the initial value starting at the beginning of the document. The distance between the two segments is generally the distance between the sequence numbers. Any exact match of the part score of the text to be matched to the part score of any section of text in the document is identified. If the location of the exact match is at the expected location of the text being sought, the text sought to be matched is identified as being matched. If an exact match of locations is not found, but an exact match of part scores is found, the location of a section of text in the document that has a matching part score that is nearest in distance to the expected location of the text to be matched, is identified as the location of the text sought to be match. If an exact match is not identified, a close match is sought. At least one close match of part scores is identified and the close match that is nearest in distance to the expected location of the text to be matched is the identified as the location of the text sought to be matched. If a close match cannot be identified, the search is considered unsuccessful. A segment can thus be considered orphaned if a close match, based on a threshold defined by the implementor, is not found.

In a further aspect, the present invention is directed to a method for locating data in a document. In one embodiment the method includes calculating a signature for the data corresponding to a marker in a first version of the document. In a second version of the document, a signature is calculated for each block of data in the second version. The signature of the data from the first version is compared with each signature calculated in the second version. Any exact match of signatures is identified. In the second version of the document, a distance is computed from an expected location of the signature for the data corresponding to the marker in the second version of the document to any matching signature identified. A marker is posted in the second version of the document at a location corresponding to location of any matching signature that is nearest to the expected location.

### BRIEF DESCRIPTION OF THE DRAWINGS

The foregoing aspects and other features of the present invention are explained in the following description, taken in connection with the accompanying drawings, wherein:

FIG. 1 is a block diagram of a system incorporating features of the present invention.

FIG. 2 is a flowchart illustrating one embodiment of the method of the calculation of a signature of a section of text in accordance with features of the present invention.

FIG. 3 is an illustration of one embodiment of a signature for a section of text calculated in accordance with features of the present invention.

FIG. 4 is a flow chart illustrating one embodiment of a method incorporating features of the present invention.

FIG. 5 is a block diagram of one embodiment of an architecture that can be used to practice the present invention.

FIG. 6 is an illustration of an application of one embodiment of the present invention to a word processing application.

FIG. 7 is an illustration of a tabular form of annotation details from the annotations shown in FIG. 6.

FIG. 8 is a flowchart of another embodiment of a method incorporating features of the present invention.

FIG. 9 is a flowchart of an embodiment of a method of matching a section of text in a document in accordance with features of the present invention.

### DETAILED DESCRIPTION OF THE PREFERRED EMBODIMENT(S)

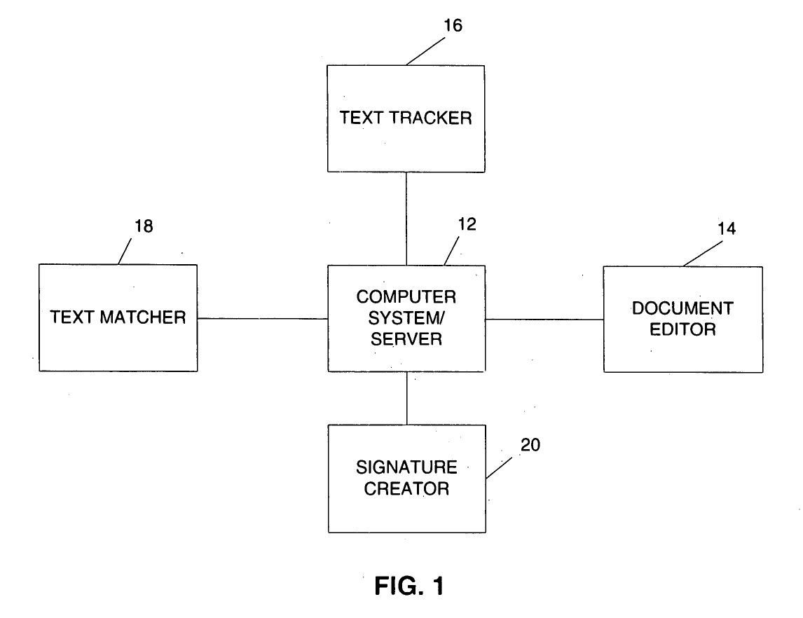

Referring to FIG. 1, a perspective view of a system 10 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, the system 10 can include a computer system or server 12 that is adapted to create, process and manipulate documents, including document editing. As such, the system 10 can include a document editor 14, a text tracker system 16, a text matcher system 18 and a signature creator and calculator system 20. In alternate embodiments, the present invention can include such other suitable devices and systems for matching and locating text in a document. A text tracker 16 can be used to create signatures for sections of text in the document in accordance with features of the invention and calculate positions of the sections of text within a document. A text matcher 18 can be used to find exact and close matches of text in a document as well as calculate relative positions of text in the document in accordance with features of the present invention.

The present invention allows text in a document to be located even if the document is modified from its original form, such as if for example, text is added to or deleted from the document. In one embodiment this includes creating a signature for a section of text that needs to be matched and a signature for each section of text in the document being searched. In one embodiment, a signature can be made up of, for example, 28 elements, one for each letter of the alphabet, one for any numeric character and one for any separator (e.g. space, tab). In alternate embodiments, the signature can be made up of any suitable number of elements.

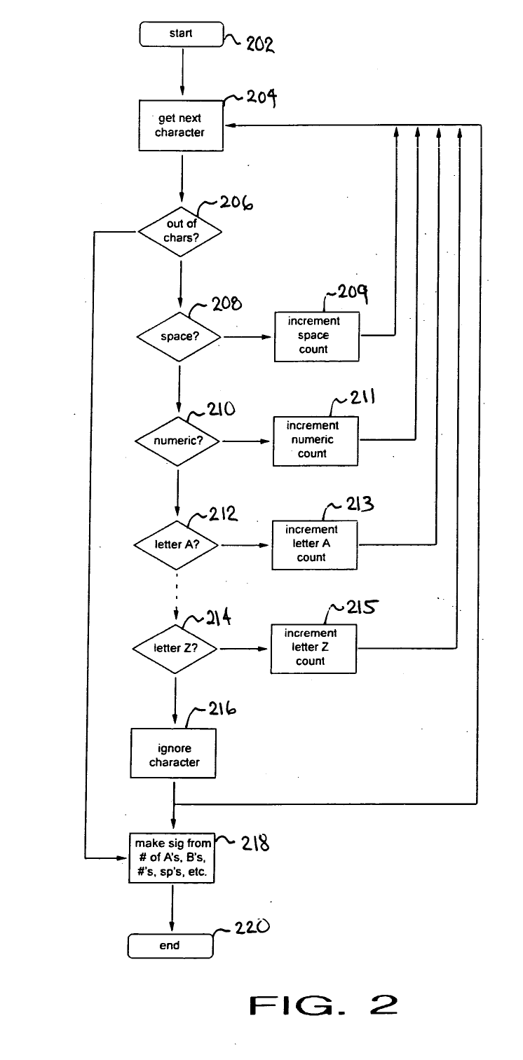

One embodiment of a method for calculating a signature for text is illustrated in FIG. 2. The algorithm for calculating a signature for a section of text begins 202 by seeking 204 a character from the search string. If no characters are found 206, the signature is ready to be formulated 218. However, if a character is found 206, it is determined what the character is (208-214). If the character is a space 208, the space count is incremented 209. If the character is numeric 210, the numeric count is incremented 211. The numeric count could include a count for each numeric individually, or the numerics taken collectively. For example, if the section of text includes the numerics 1, 1, 4, and 9, the numeric count could be 2 for the numeric 1, and 1 for each of the numerics 4 and 9. In a collective numeric situation, the numeric count would be 4.

The process then moves to count any letters in the section. If the character is the letter A 212, the letter A count is incremented 213. A similar process and counted can be performed for each letter of the alphabet being used, up to and including the last letter 214 of the particular alphabet and a corresponding counter 215. For purposes of explanation of the present invention, the English language alphabet is illustrated, however in alternative embodiments, any suitable alphabet can be used with a corresponding number of elements and element counters. Similarly, counters can be set up for any desired characters, such as for example, punctuation, brackets and symbols. If the character is not one that has been assigned an element space and counter as described with reference to FIG. 2, the character can be ignored 216. It is then determined if any other characters 204 have not been counted. If all characters have been counted, then a signature is created 218 from the number of spaces, the number of numerics and the number of each letter.

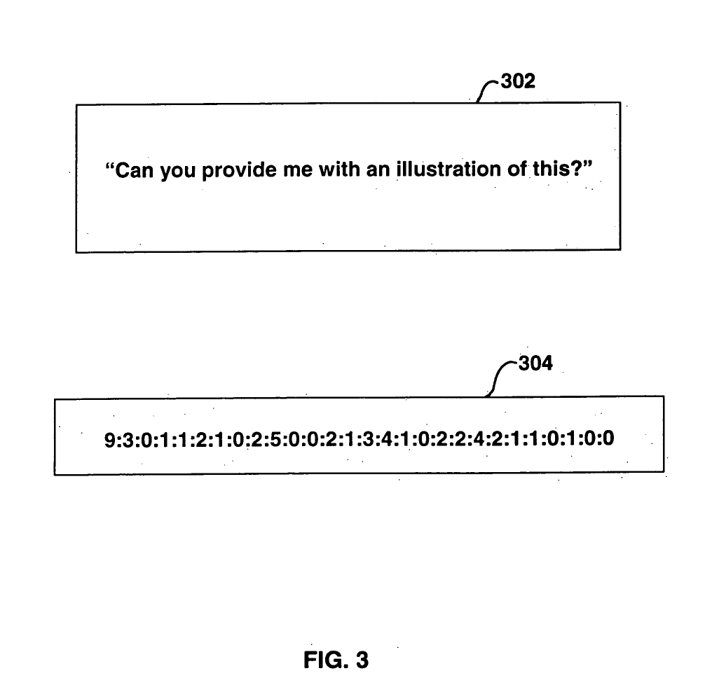

For example, referring to FIG. 3, a section of text 302 is shown with a corresponding signature 304. The signature 304 comprises 28 elements, where the element order comprises the number of spaces, the number of punctuation marks, the number of numerics, and then an separate element the number of each letter the alphabet. Thus, the text 302 “Can you provide me with an illustration of this?” comprises 9 spaces, 3 punctuation characters and 0 numerics. In this fashion, each section of text in the document will have a signature that is relatively or nearly unique. It is a feature of the present invention to calculate a signature for each section of text in a document that can be utilized for purposes of comparison to other signatures of text sections in the document. The section of text for which the signature is being calculated is generally defined as a paragraph beginning with a reference number and ending with a period. In alternate embodiments, any suitable or desired parameters can be defined for a start and an end of a section. A section can be any user defined parameter. A section does not have to be a whole sentence or paragraph, and can rely for example on tags to identify and separate sections. A section will then be based on the beginning and ending of tags. The section can be based on whatever break-up the user desires so that a section can compute and relocate its position within a document.

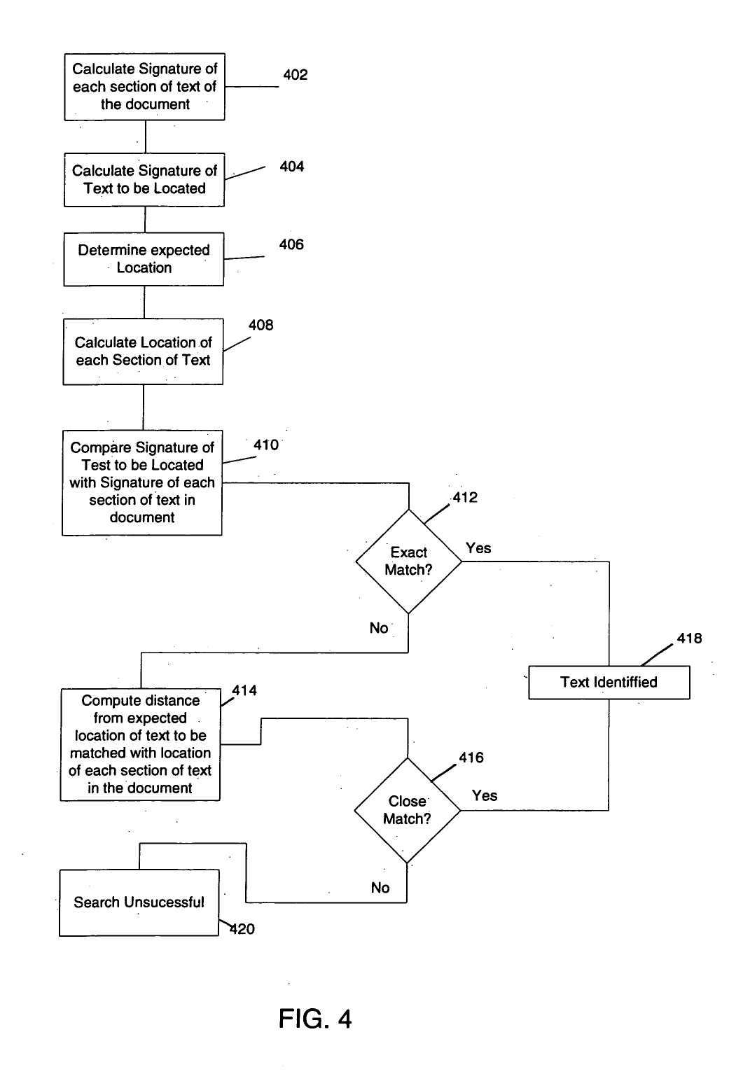

Referring to FIG. 4, one embodiment of a method of searching for a section of text in a document is described.

A signature is calculated 402 for each section of text in the document. The signature of the text to be located or matched is also calculated 404. The expected location of the text to be matched is calculated 406 and the position or location of each section of text in the document is determined 408. A comparison 410 is then made between the signature of the text to be matched and the signature of the section at the expected location of the text to be matched. If an exact match is found 412, the text is found 418. If an exact match is not found, a distance is computed 414 between an expected location of the text and the location of each section of text in the document. It is determined 416 whether a close match can be Identified (in comparison scoring) which is nearest to the expected location of the text to be matched. A close match can be a factor of the correspondence in signatures and the proximity in distance of the close match to the expected location of the text. If a close match is determined 416, that location is identified 418 as the location of the text to be matched. A close match might be a section of text that has an identical signature to the text to be matched that is nearest to the expected location of the text. A close match might also include a section of text that has a signature that is comparatively similar to the signature of the text to be matched and is nearest to the expected location of the text. Generally, any suitable pre-defined parameters can be used to define a close match, and could include allowing for certain variances in the number of each of the elements that make up the signature or the total score of the signature, for example. The present invention is not intended to be limited by the scope of the definition of a close match.

The tolerance level for determining an acceptable close match can be factored into the algorithm that compares two signatures.

If a close match is not found 416, the search is rendered unsuccessful 420. This can be an appropriate state for text that has been altered beyond recognition. This text might be considered orphaned by the application, or not matchable.

With reference to FIG. 4, generally, to compare two signatures, the sum of twenty-eight (28) part scores is computed. It should be noted first that there are two adjustable constants, an addition factor and a multiplication factor, both of which may be adjusted or left as default values of eight (8) and one hundred (100) respectively. Each part score is computed using the corresponding elements of the two signatures, each of which has been first increased by the addition factor. If these two elements are equal, the part score is equal to the multiplication factor. Otherwise, the smaller of the two elements is first multiplied by the multiplication factor and then divided by the larger of the two elements. These values can be used to fine tune the computation of the part sum by adjusting the granularity with which comparisons are made. If we are comparing two signatures for the letter A and we have a large ADD factor, small differences will not have as much impact as they would if the ADD factor was small. If we have a large MULT factor, this has the affect of increasing the importance of accuracy required as compared with a small MULT factor. The larger MULT factor magnifies the differences between signatures overall, where the large ADD factor diminishes the difference in individual letters.

One example of this formula or algorithm may be described as a pseudo code as follows in Table 1:
initialize final-sum;
for each pair of elements in the two signatures{
num1 is the smaller of the two;

num2 is the larger of the two;

TABLE 1

if ( ( num1 == num2 ) ) {

part-sum = mult-factor;

}
else {

part-sum = mult-factor * (num1 + add-factor) /
(num2 + add-factor) ;

}
add part-sum to final-sum;

}

Referring again to FIGS. 1 and 4, in one embodiment, the signature can be calculated 402, 404 in the signature creator 20 for each section of text. The text tracker 16 can determine 406 the expected location of the text and the text matcher 18 can use that information to look to that location to compare 410 signatures. If the text matcher 18 finds an exact match 412 between the signature of the text to be matched and the signature of the section of text at the expected location, the text is found 418. If an exact match is not identified, that would mean that the text has been altered, or shifted or moved from its original location in the document. The text tracker 16 can calculate the distance from the expected location of the text to each other section of text in the document. The text matcher 18 can then use this location information to search for a close match as described above, using for example the algorithm illustrated in Table 1. The close match is a factor of the correspondence in signatures and the proximity in distance of the close match to the expected location of the text. The present invention looks for an exact match 412 or a close match 416 in signatures and then determines how far away from the expected location of the text the exact signature match or close signature match is. If a signature of a section of text is close enough in value to the signature of the text to be matched, and close enough in distance, it is identified as the location of the text to be matched.

However, if the change to the text of the document is too substantial, for example if the entire sentence or section has been rewritten, then a match will not be found 420.

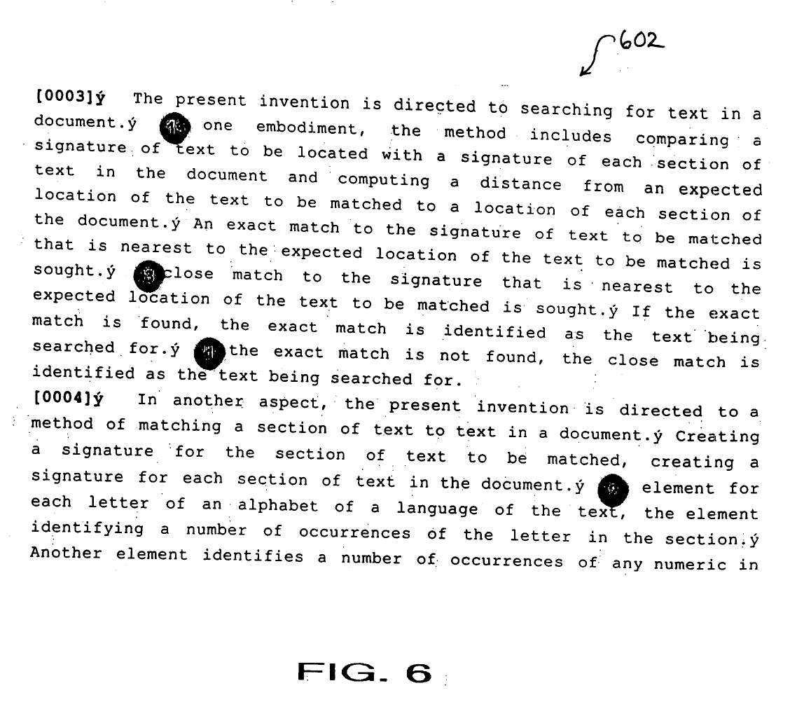

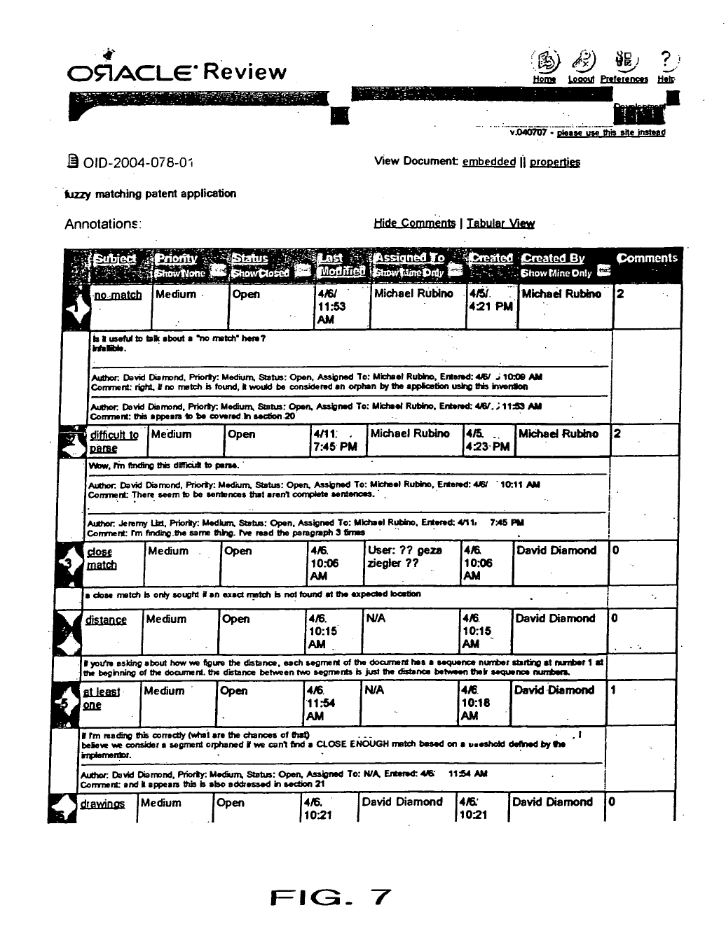

The present invention can be useful when annotations are associated with document sections. The annotations need to be able to associate themselves with the section of text to which they belong, even if the text changes somewhat or moves. One embodiment of the use of annotations in a document is illustrated with respect to FIG. 6. In this illustration, a word processing document has been created using for example, the document editor 14 of FIG. 1. The section of text 602 shown in FIG. 2 is being edited, using for example, the invention disclosed in U.S. patent application Ser. No. ______, filed on ______, 2005 as Express Mail No. , entitled COLLABORATIVE DOCUMENT REVIEW, by David Lane Diamond, Michael S. Rubino, and Jeremy Lizt, and assigned to the assignee of the instant application, the disclosure of which is incorporated herein in its entirety. For example, as shown in FIG. 6, during a review of the document section 602, four annotations, numbered as 19, 3, 1 and 2, were applied to the section 602. FIG. 7 illustrates one embodiment of a tabular view of the comments and other information associated with the annotations. Annotations 19, 3 and 1 are anchored or connected with the paragraph numbered 0003. The annotation 2 is anchored with a subsequent paragraph numbered 0004. In the situation where one or more new paragraphs or text are inserted between paragraphs 0003 and 0004, the second annotation 2 must be able to move or reposition in order to remain with the section of text to which it originally belonged. Using the present invention, the annotation can find the section of text to which it originally belonged and reposition itself.

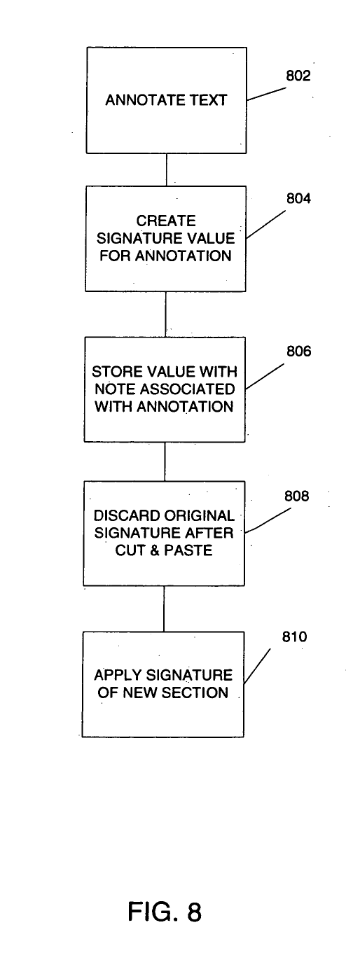

In one embodiment, referring to FIG. 8, if a user is annotating 802 a section of text, a signature value for the section is determined 804. The user then writes the annotation, takes the signature for the section and stores 806 it with the note.

If an annotation is moved, such as for example, in a “cut and paste” operation, the old signature is discarded 808. The signature of the section to which the annotation is moved is applied 810, or anchored. Anchoring, as that term is used herein, generally refers to fixing the annotation in the general area of the section of text to which the note applies, the signature of where you are anchored to and the location of where you expect to be.

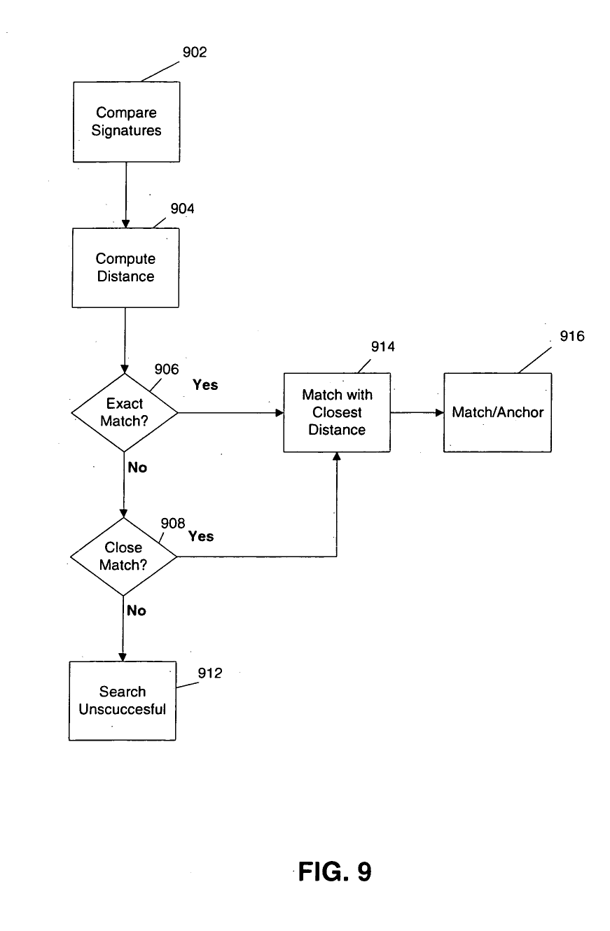

Referring to FIG. 9, an embodiment of a method for searching and matching a section of text in a modified document is illustrated. The searching for a matching section of text is achieved by calculating 902 and comparing the signatures of text in the document. The calculated signatures and the results of the comparison can be stored in any suitable fashion. A distance is then calculated 904 from the expected location of the section of text to be matched to the location of each section of text in the document. It is then determined 906 if there are any exact signature matches. If yes, the exact signature match that whose section location is the closest to the expected location of the section of text to be matched is identified 914. An exact signature match whose section location is nearest to the expected location is ideal. That section of text is identified as the location of the section of text to be matched and the annotation is anchored to that section in the revised document.

If an exact match in signatures cannot be identified, it is determined whether or not there is a close match 908 of signatures (in comparison scoring). Each close match is paired 914 with a calculated section location distance 904. The close match whose section location is nearest to the expected location is acceptable and can be considered the location of the section of text to be matched. The match is identified 916 and the annotation is anchored at that location.

If a close match is not identified, the search can be rendered unsuccessful 912, which is an appropriate state for text that has been altered beyond recognition.

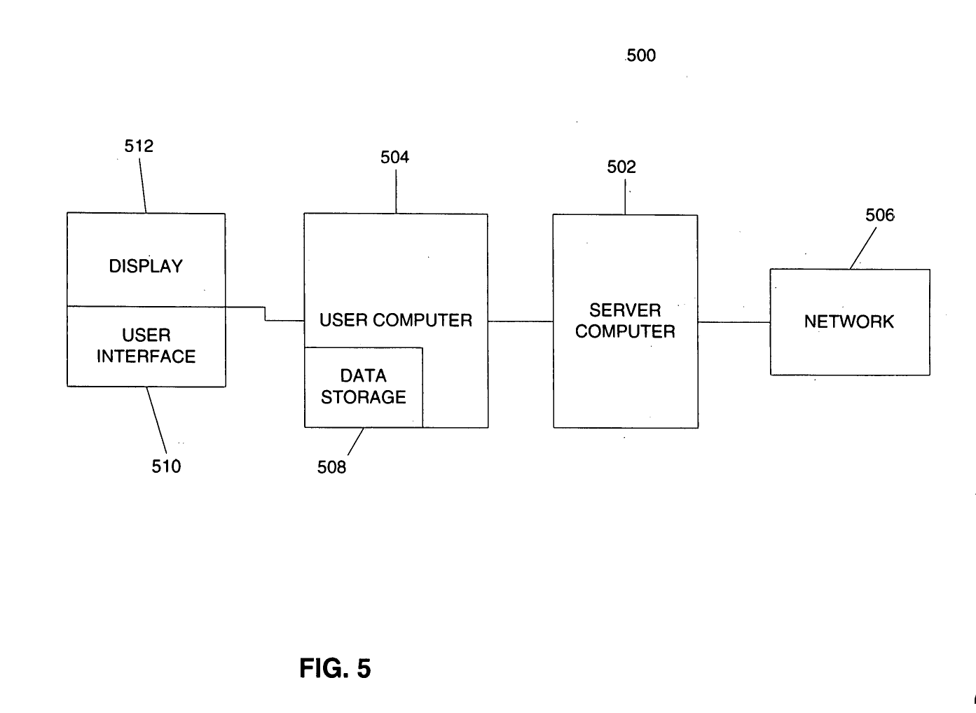

The present invention may also include software and computer programs incorporating the process steps and instructions described above that are executed in different computers. In the preferred embodiment, the computers are connected to the Internet. FIG. 5 is a block diagram of one embodiment of a typical apparatus 500 incorporating features of the present invention that may be used to practice the present invention. As shown, a computer system 502 may be linked to another computer system 504, such that the computers 502 and 504 are capable of sending information to each other and receiving information from each other. In one embodiment, computer system 502 could include an origin server or computer adapted to communicate with a network 506, such as for example, the Internet or an Intranet. Computer systems 502 and 504 can be linked together in any conventional manner including a modem, hard wire connection, fiber optic link or such other suitable network connection. Generally, information can be made available to both computer systems 502 and 504 using a communication protocol typically sent over a communication channel or through a dial-up connection on ISDN line. Computers 502 and 504 are generally adapted to utilize program storage devices embodying machine readable program source code which is adapted to cause the computers 502 and 504 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 502 and 504 may also include a microprocessor for executing stored programs. Computer 502 may include a data storage device 508 on its program storage device for the storage of information and data. The computer program or software incorporating the processes and method steps incorporating features of the present invention may be stored in one or more computers 502 and 504 on an otherwise conventional program storage device. In one embodiment, computers 502 and 504 may include a user interface 510, and a display interface 512 from which features of the present invention can be accessed. The display interface 512 and user interface 510 could be a single interface or comprise separate components and systems. The user interface 508 and the display interface 512 can be adapted to allow the input of queries and commands to the system, as well as present the results of the commands and queries.

The present invention enables text matching functionality for a documentation review server which would increase productivity of teams of users engaged in review of documents.

Without such a solution, a section of text in a document becomes lost as soon as such it is moved or altered in any way. The advantage of the solution is that it allows the section to be moved and/or altered while retaining the matchability of the section of text.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of searching for text in a document comprising:
comparing a signature of text to be located with a signature of each section of text in the document;
computing a distance from an expected location of the text to be located to a location of each section of the document;
finding an exact match to the signature of text to be located that is nearest to the expected location of the text to be located;
if an exact match is not found, finding a close match to the signature that is nearest to the expected location of the text to be located; and
identifying the exact match or the close match as the text to be located.

2. The method of claim 1 further comprising, if neither the exact match nor the close match are found, rendering the search unsucessful.

3. The method of claim 1 wherein the comparing of the signature of the text to be located with the signature of each section of text in the document comprises:
computing a sum of part scores in each section of the document;
comparing the computed sum of part scores of each section with a sum of a part score of the text to be matched; and
identifying an acceptable close match on a basis of the comparison of the computed part scores.

4. The method of claim 1 wherein a signature comprises a series of twenty-eight elements, including one element for each letter of the alphabet, one element for any numeric character and one element for any character separator.

5. The method of claim 4 wherein a comparison of two signatures comprises comparing a sum of twenty-eight part scores.

6. The method of claim 4 wherein each part score is computed by:
increasing each corresponding element of the signature of the text to be matched and a signature of a section of text being compared by an addition factor;
determining if a part score of the text to be matched is equal to a part score of the section of text being compared;
wherein if the part scores are equal, the part scores are equated to a multiplication factor; and
if the part scores are not equal:
identifying a larger part score and a smaller part score;
multiplying the smaller of the part scores by a multiplication factor and dividing the multiplied part score by the larger part score.

7. The method of claim 1 further comprising, prior to comparing:
dividing the text to be matched and the text of the document into at least one section; and
creating a signature for each of the at least one section, each signature comprising:
one element for each letter of the alphabet, the element for each letter identifying a number of occurrence of a letter in the section;
one element for any numeric character in the section, the element identifying a number of occurrences of any numeric character in the section; and
one element for any separator in the section, the element identifying a number of occurrences of any separator in the section.

8. The method of claim 1 wherein each signature comprises twenty-eight elements.

9. The method of claim 7 wherein each section comprises a pre-determined portion of text in the document.

10. The method of claim 7 wherein each section comprises a sentence in the text of the document.

11. A method of matching a section of text to text in a document comprising:
creating a signature for the section of text to be matched;
creating a signature for each section of text in the document, each signature comprising:
one element for each letter of an alphabet of a language of the text, the element identifying a number of occurrences of the letter in the section;
one element identifying a number of occurrences of any numeric in the section;
one element identifying a number of occurrences of any separator in the section;
calculating a part score for each signature by summing each element in each signature;
comparing, in turn, a part score for the text to be matched with each section of text in the document;
compare a distance of an expected location of the text to be matched in the document with a location of each section of text in the document;
identifying any exact match of the part score of the text to be matched to the part score of any section of text in the document;
identifying as the matching text a section of text in the document that has an exact match in part score and that is nearest to the expected location of the text to be matched; and if an
exact match is not identified;
identifying at least one close match by: identifying a part score that is closest to the part score of the text to be matched, and determining if a location of the identified part score is within a pre-determined distance range to qualify as the close match.

12. The method of claim 11 wherein a part score is calculated by:
adding an addition factor to each corresponding element of two signatures to be matched;
determining if a sum of elements of each signature is equal and if the sum of elements is equal identifying the part score as equal to a
multiplication factor; and if the sum of each signature is not equal:
multiplying a smaller of the sum of elements of the two signatures by the multiplication factor; and dividing a result of the multiplying by a larger of the sum of elements of the two signatures.

13. The method of claim 11 wherein a section comprises a pre-determined portion of text in the document, each section being separated by a tag.

14. The method of claim 11 wherein a failure to find an exact match or at least one close match renders the search unsuccessful.

15. A method for locating data in a document comprising:
calculating a signature for the data corresponding to a marker in a first version of the document;
comparing, in a second version of the document, the signature of data corresponding to the marker with an exact match to the signature;
comparing, in a second version of the document, the signature for the data corresponding to the marker to a signature for each section of data in the second version of the document;
computing a distance from an expected location of the signature for the data corresponding to the marker in the second version of the document to a matching signature; and
posting the marker in the second version of the document at a location in the second version of the document corresponding to the matching signature that is nearest the expected location.

16. The method of claim 15 wherein the signature is calculated by:
calculating values for a number of occurrences of each letter of the alphabet in the section and inserting each calculated value into a pre-determined element position in a sequence of elements, each per-determined element position corresponding to a letter of the alphabet;
calculating values for a number of occurrences of each numeric character in the section and inserting each calculated value into a pre-determined alpha element position in the sequence of elements, each pre-determined numeric element position corresponding to a respective numeric character; and
calculating a number of occurrences of any separators in the section and inserting each calculated number into a pre-determined element position in the sequence of elements that corresponds to the separator.

17. The method of claim 15 wherein the signature comprises twenty-eight elements, one for each letter of the alphabet, one for a number of any numeric characters and one for a number of any separators.

18. The method of claim 11 further comprising calculating the distance by calculating a difference in sequence numbers assigned to sections of the document, with an initial sequence number assigned to a beginning section of the document.
